(19) United States
(12) Patent Application Publication
(10) Pub. No.: US 2007/0099043 A1
(43) Pub. Date: May 3, 2007

(54) Fuel reaction control device for fuel cell system

(76) Inventor: Chun-Chin Tung, Taipei (TW)

Correspondence Address: G. LINK CO. LTD., 3550 BELL ROAD, MINOOKA, IL, 60447, US

(21) Appl. No.: 11/263,935

(22) Filed: Nov. 2, 2005

(51) Int. Cl. H01M 8/04

(52) U.S. Cl. 429/22; 429/34

(57) ABSTRACT

The present invention relates to a device having automatic control of outside air entry into the fuel cell system. The device comprises a microprocessor control circuit, a light indicator, and an air intake device. The microprocessor control circuit monitors and displays whether outside air needs to be introduced into the fuel cell system to undergo electrical-chemical reaction with the fuel inside the fuel cell so as to obtain current. The light indicator receives and displays the condition under the control of microprocessor control circuit to help the user learn about the current state of fuel cell and determine whether to activate the air intake device. The air intake device consists of an air intake on/off mechanism, a fan, and activation control device.

### FIELD OF THE INVENTION

The present invention relates to a fuel reaction control device for fuel cell system, more particularly, a device that monitors and operates the entry of outside air into the fuel system by means of automatic control.

### BACKGROUND OF THE INVENTION

Conventional fuel cell is a system that generates direct current resulting from electrical-chemical reaction of outside air and internal fuel, which comprises a catalyst-containing anode, a cathode, and ion-conducting electrolytes. When the load is connected between the anode and the cathode, a power loop is formed where current travels from anode to cathode through the load. Differing from conventional batteries, when fuel is continuously supplied to the fuel cell, the electrical energy is maintained. The final products of such electrical-chemical reaction are water molecules. Hence fuel cells provide a clean energy source that is congruent with the goal of environmental protection. In typical hydrogen fuel cells, free electrons and protons are released from hydrogen molecules when the anode reacts, whereas the cathode consumes the free electrons. Outside air molecules are introduced into the fuel cell system from cathode that oxygen in the air undergoes chemical reaction with the free electrons that travel to cathode through the loop to become a hydroxide, i.e. the final product is water molecule. In prior art, a fan device is added to the air intake to increase airflow so as to effectively control the electrical-chemical reaction of outside air and internal fuel. An opening/closing device is also disposed anterior to the fan to control the on and off of fuel cell. But prior technologies utilize only simple driving element to open and close the air intake structure, and the air intake structure merely controls air intake without letting the user or maintenance people know whether it is activated or not, hence adding uncertainty to the use of fuel cell system and calling for improvement.

### SUMMARY OF THE INVENTION

The object of the present invention is to provide a fuel reaction control device for fuel cell system, which automatically undergoes or stops electrical-chemical reaction based on power needs, and allows users to have a better grasp of the activities in the fuel cell through a monitoring and display device.

In accordance with the aforesaid object, the present invention discloses a fuel reaction control device for fuel cell system, comprising: a fuel cell sandwiched between an air intake device and a partition layer, where the partition layer is a membrane of prior art for preventing the spillage of water vapor; the air intake device contains a roll-up curtain type mechanical linkage member, a fan, a proximity switch, and a photo interrupter. The action of the entire air intake device is to control the entry of outside air. It can regulate the on and off of fan through the fan and photo interrupter, and analyze the turning speed of fan through the photo interrupter to determine the amount of airflow needed. This electronic message is then transmitted to a microprocessor control device via an electron loop, which, following analysis, sends back the decision on the turning speed of fan and provides greater amount of outside air into the fuel cell system to accelerate the reaction of oxygen in the air and hydrogen in the fuel. The proximity switch can convey the on/off state of roll-up curtain type mechanical linkage member to the microprocessor control device via the electron loop. The microprocessor control device transmits the result to the light indicator through its communication with the periphery for the display of result in the form of light signal to let the user read directly the current state of fuel cell.

### BRIEF DESCRIPTION OF THE DRAWINGS

FIG. 1 is a diagram showing the control actions of the fuel reaction control device for fuel cell system according to the invention; and

FIG. 2 is the flow chart of the control actions of fuel reaction control device for fuel cell system according to the invention.

### DETAILED DESCRIPTION OF THE INVENTION

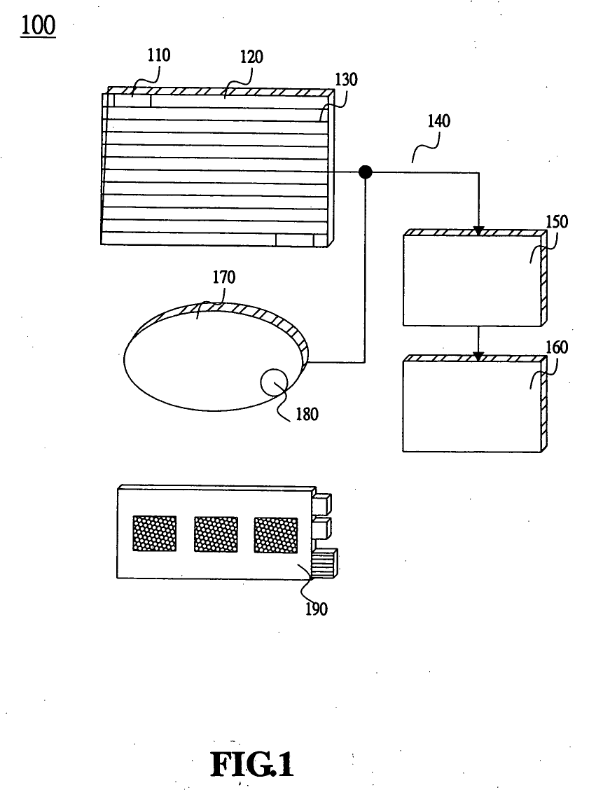

FIG. 1 is a diagram showing the control actions of the fuel reaction control device for fuel cell system according to the invention. As shown, the control device 100 comprises an air intake body 120, a proximity switch 110, a roll-up curtain type mechanical linkage member 130, a fan 170, a photo interrupter 180, a microprocessor controller 150, and a light indicator 160. The proximity switch 110 and photo interrupter 180 are linked with microprocessor controller 150 via an electron loop 140. The microprocessor controller 150 sends the analyzed electronic signal to light indicator. It can also transmit the controlled electronic signal to fan 170 through electron loop 140 to control the turning speed of fan. The monitoring of turning speed is carried out by photo interrupter 180, where the frequency of interruption is analyzed by microprocessor control device 150 to learn the turning speed of fan. The control of air intake body 100 is effected by the opening and closing of roll-up curtain type mechanical linkage member 130 under the control of microprocessor controller 150 and the opening/closing of roll-up curtain type mechanical linkage member 130 is monitored by proximity switch 110 to let the user learn about the current state of the fuel reaction control device 100. The fuel reaction control device 100 for fuel cell system disclosed herein is suitable for direct integration into the notebook computer, where the microprocessor controller 150 is implemented in an integrated control IC which can communicate with CPU to achieve the object of monitoring and control.

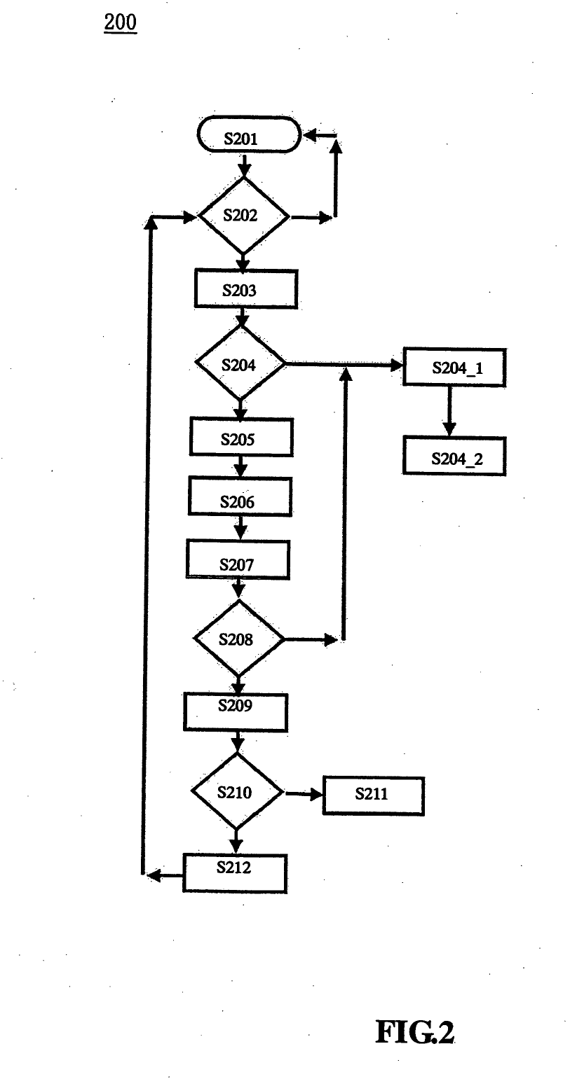

FIG. 2 is the flow chart of the control actions of fuel reaction control device for fuel cell system according to the invention. First step S201 entails the initial state of fuel reaction control device 100, i.e. the roll-up curtain type mechanical linkage member 130 is not yet opened where the interior of entire fuel cell 190 is closed to the outside. Step S202 involves the communication between IC and system to determine whether electric power should be turned on; if not, the system keeps its initial state S201, or else, power is needed. Step S203 concerns the opening of roll-up curtain type mechanical linkage member 130 where curtain 130 is rolled up, and step S204 determines whether curtain 130 is opened normally; if the roll-up curtain 130 is not opened, the message is transmitted to microprocessor controller 150 via the electron loop 140 (step 204-1), and the microprocessor controller 150 would analyze this message and send the non-opening signal to signal indicator 160 (step 204-2). Conversely, if the roll-up curtain 130 is opened normally, this message is transmitted to microprocessor controller 150 via electron loop 140, where the microprocessor controller 150 analyzes and sends the normal opening signal to light indicator 160 to show that roll-up curtain 130 is in open state (step S205). Because of the action in step S205, outside air enters the interior of fuel cell 190 through the open curtain 130 and undergoes electrical-chemical reaction to produce the energy needed (step S206). When the inflow of outside air is inadequate that more efficient reaction is desired, fan 170 is turned on (step S207), and photo interrupter 180 is used to check whether the fan is turned on (step S208). If the fan 170 is not turned on normally, this message is transmitted to microprocessor 25 controller 150 via the electron loop 140 (step S204-1) and the microprocessor controller 150 would analyze this message and send this electronic signal to light indicator 160 (step 204-2). Conversely, fan 170 is opened normally. When the air intake is found inadequate, step S210 determines whether to increase the turning speed of fan 170; if the intake flow is normal, the original turning speed of fan 170 is maintained (step S211); if not, current is increased to raise the turning speed of fan 170 so as to increase the air intake (step2l2). At this time, monitoring the on/off of power supply continues (step S202). If the fuel cell 190 continues to be in the “on” state, the flow process of S203˜S201 is maintained. Conversely, power supply is shut off and the system goes back to the initial state S201, that is, the interior of fuel cell 190 is closed to the outside without undergoing any electrical-chemical reaction.

What is claimed is:

1. A fuel reaction control device for fuel cell system, comprising:
an air intake device for controlling the entry of outside air into the fuel cell system and having an acceleration device, a monitoring device, and a roll-up curtain type mechanical linkage member;
wherein the acceleration device is monitored, turned on or off, and has turning speed adjusted by a microprocessor controller; the monitoring device monitors the open or close state of acceleration device and the roll-up curtain type mechanical linkage member and transmits an electronic signal to the microprocessor controller; the roll-up curtain mechanical linkage member is connected to a monitoring device, through which, the state of linkage member is sent to the microprocessor controller.

2. The fuel reaction control device of claim 1, wherein the acceleration device is a fan and a photo interrupter used for increasing the airflow and monitoring the turning speed.

3. The fuel reaction control device of claim 1, wherein the microprocessor controller is a control IC communicable with the fuel system, where the communication is achieved via I²C or SMBus.

4. The fuel reaction control device of claim 1, wherein the monitoring device is a proximity switch for sending the state of roll-up curtain type mechanical linkage member to the microprocessor controller.

5. The fuel reaction control device of claim 1, wherein the roll-up curtain type mechanical linkage member can have a plurality of blades that are opened or closed simultaneously.

6. The fuel reaction control device of claim 5, wherein the blades are opened at 90-degree angle or closed at 180-degree angle.

7. A fuel reaction control display device for fuel cell system, comprising:
a light indicator through which the electronic signal showing the state inside the fuel cell as sent by a microprocessor controller is displayed;
wherein the light indicator is disposed with a driver circuit to drive the display of signal.

8. The fuel reaction control display device of claim 7, wherein the light indicator is a LED, a LCD or a seven-segment display device.
